(19) United States
(12) Patent Application Publication
(10) Pub. No.: US 2019/0387126 A1
(43) Pub. Date: Dec. 19, 2019

(54) IMAGE INSPECTION DEVICE AND IMAGE FORMING APPARATUS

(71) Applicant: KONICA MINOLTA, INC., Tokyo (JP)

(72) Inventor: Yoko Shiraki, Ebina-shi (JP)

(73) Assignee: KONICA MINOLTA, INC., Tokyo (JP)

(21) Appl. No.: 16/441,305

(22) Filed: Jun. 14, 2019

(30) Foreign Application Priority Data
Jun. 18, 2018 (JP) 2018-115279

(51) Int. Cl. H04N 1/40; G06K 15/02; H04N 1/00; G06T 7/00

(52) U.S. Cl. CPC H04N 1/40; G06K 15/023; G06T 2207/30176; G06T 7/0002; H04N 1/00806

(57) ABSTRACT

An image inspection device includes an image reader that reads a printed matter obtained by forming an image on a transparent support medium; a switcher that changes a reading condition by the image reader; a controller that performs reading in the image reader on a same printed matter for a plurality of times by changing the reading condition in the switcher; and a determiner that inspects the printed matter on a basis of data read by the image reader for the plurality of times.

The entire disclosure of Japanese patent Application No. 2018-115279, filed on Jun. 18, 2018, is incorporated herein by reference in its entirety.

### BACKGROUND

### Technological Field

The present invention relates to an image inspection device and an image forming apparatus, and more particularly to an image inspection device and an image forming apparatus suitably applied in a case where inspection of an image formed on a transparent support medium is performed.

### Description of the Related Art

Some of image forming apparatuses that form an image on a paper include an image inspection device. Image inspection devices include an image reading sensor and inspect whether image formation has been correctly performed by analyzing image data obtained by reading a paper by the image reading sensor. Some image inspection devices are incorporated in an image forming apparatus, whereas some are configured separately from an image forming apparatus and is arranged connected to the image forming apparatus.

There are cases where a transparent resin film (transparent support medium) is used as a paper on which an image is formed by the image forming apparatus, and thus it is preferable to perform inspection also on an image formed on the transparent resin film by an image inspection mechanism.

When an image formed on a transparent resin film is read by an image reading sensor, it is necessary to switch the background color of the transparent resin film between white and black depending on the image to be read. For example in a case of inspection of an image represented only by a white toner on the transparent resin film, it is necessary to confirm the image formed by the white toner with a black background. Meanwhile, in a case of inspection of an image represented on a transparent resin film by toners other than the white one such as cyan, magenta, yellow, and black (hereinafter, these colors are collectively referred to as “CMYK”), it is necessary to confirm the image of the respective colors with a white background.

When a white image is read with a white background, it cannot be distinguished whether the read white color is of an image by the white toner or of the background color, thereby hindering proper inspection. Meanwhile in a case of an image of other colors other than white, when the background color is black, it cannot be distinguished whether the black color is that of the toner or that of the background color, thereby hindering proper inspection.

JP 2012-153088 A describes that an inspection pattern for ink nozzle inspection is printed on a transparent medium and that the background color is switched between white and black depending on the color of the inspection pattern. Specifically, it is described that black is used as the background color of an image reading sensor for a part where an inspection pattern of a white ink is printed and that white is used as the background color of the image reading sensor for a part where an inspection pattern of inks of other colors is printed.

As described in JP 2012-153088, in a case where a region in which an image is formed on a transparent resin film by a white toner and a region in which an image is formed by CMYK toners can be distinguished in advance like in the inspection pattern, the background color can be changed for each of the regions to perform appropriate image inspection.

However, in a case of printing processing of actually forming various images on a transparent resin film using an image forming apparatus, there are many cases where it is difficult to determine which background color is to be selected depending on an image to be formed. For example in a case where the same image is to be formed on a large number of transparent films, an operator can select by operation the optimal background color for the image to be formed. However, it is practically impossible to manually select the background color for each sheet in a case where images and colors formed on transparent resin films are different for each sheet.

Moreover, in a case where a part where a white image is formed and a part where a color image is formed are mixed in one sheet of transparent resin film, a region suitable for reading with a white background color and a region suitable for reading with a black background color are mixed in one sheet of transparent resin film. In such a case, in the related art, it is difficult to select the optimal background color.

When a color image is formed on a transparent resin film, there are cases where a white layer is formed as foundation in order to improve development of colors of the color image and a color image layer is formed thereover by CMYK toners. In such a case, two possible cases are assumed as a printing defect, which are: a defect in the white layer (lower layer) and a defect in the color image layer (upper layer): However, it is difficult to detect all these defects only by reading the surface of the image by a sensor. That is, even when a defect such as faint toner occurs in the white part in the lower layer of the image, it is difficult to detect the defect from data read from the surface by an image reading sensor.

### SUMMARY

An object of the present invention is to provide an image inspection device capable of appropriately inspecting an image formed on a transparent support medium such as a transparent resin film, and an image forming apparatus including the image inspection device.

To achieve the abovementioned object, according to an aspect of the present invention, an image inspection device reflecting one aspect of the present invention comprises: an image reader that reads a printed matter obtained by forming an image on a transparent support medium; a switcher that changes a reading condition by the image reader; a controller that performs reading in the image reader on a same printed matter for a plurality of times by changing the reading condition in the switcher; and a determiner that inspects the printed matter on a basis of data read by the image reader for the plurality of times.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a block diagram illustrating an exemplary overall configuration according to an embodiment of the present invention;

FIG. 2 is a diagram illustrating an exemplary setting screen (paper selecting screen) according to an embodiment of the present invention;

FIG. 3 is a diagram illustrating an exemplary setting screen (toner setting screen) according to an embodiment of the present invention;

FIG. 4 is a diagram illustrating an exemplary structure of an image inspector according to an embodiment of the present invention;

FIG. 5 is a schematic diagram illustrating an exemplary internal structure of a background color setter of an image inspector according to an embodiment of the present invention;

FIG. 6 is a flowchart (#1) illustrating a flow of inspection processing according to an embodiment of the present invention;

FIG. 7 is a flowchart (#2) illustrating a flow of the inspection processing according to an embodiment of the present invention;

FIG. 8 is a flowchart (#3) illustrating a flow of inspection processing according to an embodiment of the present invention;

FIG. 9 is a flowchart (#1) illustrating a flow of other inspection processing according to an embodiment of the present invention;

FIG. 10 is a flowchart (#2) illustrating a flow of other inspection processing according to an embodiment of the present invention;

FIG. 11 is an explanatory diagram illustrating exemplary reading (first example) according to an embodiment of the present invention; and

FIG. 12 is an explanatory diagram illustrating exemplary reading (second example) according to an embodiment of the present invention.

### DETAILED DESCRIPTION OF EMBODIMENTS

Hereinafter, one or more embodiments of the present invention (hereinafter referred to as “the embodiment”) will be described with reference to the drawings. However, the scope of the invention is not limited to the disclosed embodiments.

### 1. Overall System Configuration

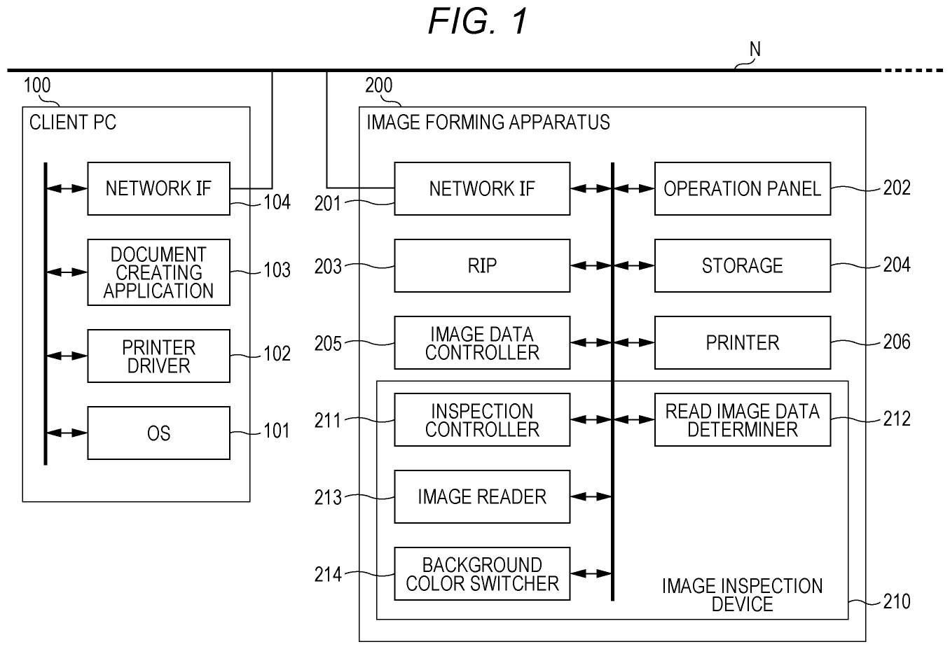

FIG. 1 is a diagram illustrating an exemplary overall configuration of the embodiment.

In the embodiment, a client computer (PC) 100 is connected to an image forming apparatus 200 via a network N, and the image forming apparatus 200 forms an image on a support medium (paper or the like) to create a printed matter. The image forming apparatus 200 of the present embodiment incorporates an image inspection device 210.

The client PC 100 includes an operating system (hereinafter referred to as “OS”) 101, a printer driver 102, a document creating application program 103, and a network interface (hereinafter referred to as “network IF”) 104.

In the client PC 100, when printing of data created by the document creating application program 103 is instructed by a user, the OS 101 activates the printer driver 102 and displays a setting screen of print conditions (print setting screen) on a display (not illustrated) of the client PC 100. When setting of print conditions by the user on the print setting screen is completed, the printer driver 102 converts the data of the application format into data of a file format for printing (page description language (PDL)).

Then, the client PC 100 transmits the converted PDL data for printing together with the setting data of the print conditions (print setting data) as a print job to the image forming apparatus 200 via the network IF 104.

When the printer driver 102 creates print data and transfers the print data to the image forming apparatus 200, there are two modes, a print mode and a save mode. In the print mode, by the print job transmitted from the client PC 100 to the image forming apparatus 200, printing is immediately performed. In the save mode, the transmitted print job is not immediately printed but is stored in a storage 204 of the image forming apparatus 200.

The image forming apparatus 200 includes a network IF 201, operation panel 202, a raster image processor (RIP) 203, the storage 204, an image data controller 205, and a printer 206. The image forming apparatus 200 incorporates the image inspection device 210. When a printed matter is generated by the image forming apparatus 200, the image inspection device 210 inspects the printed matter.

Note that the configuration that the image forming apparatus 200 incorporates the image inspection device 210 is merely an example, and the image inspection device 210 may be arranged adjacent to the image forming apparatus 200 to perform inspection by conveying the printed matter obtained by the image forming apparatus 200 to the image inspection device 210.

The network IF 201 of the image forming apparatus 200 executes communication with the client PC 100 or another device via the network N and performs data transfer processing.

The operation panel 202 displays a screen for the user to perform operation on the image forming apparatus 200 such as input of image reading conditions and an instruction to read an image. The operation panel 202 receives operation on the image forming apparatus 200 from the user by touching on a button on the displayed screen or the like and instructs respective components in the image forming apparatus 200 to perform the received operation.

The RIP 203 converts the PDL data of the print job received from the client PC 100 to create rasterized image data. In the following description, rasterized image data for printing is simply referred to as image data.

The storage 204 includes a hard disk drive (HDD) or a semiconductor memory and stores image data of a print job created by the RIP 203 and read image data read by an image reader 213 which will be described later.

The image data controller 205 controls reading and conversion of image data stored in the storage 204. The image data controller 205 also instructs the printer 206 to print a print job.

Upon receiving an instruction from the image data controller 205, the printer 206 performs printing (image formation) on a paper using the image data (rasterized image data) converted by the RIP 203. For printing on a paper, it is possible to form a white image using a white toner and to form a color image or a black image using CMYK. The type of papers on which the printer 206 performs printing is selected by user operation on the operation panel 202.

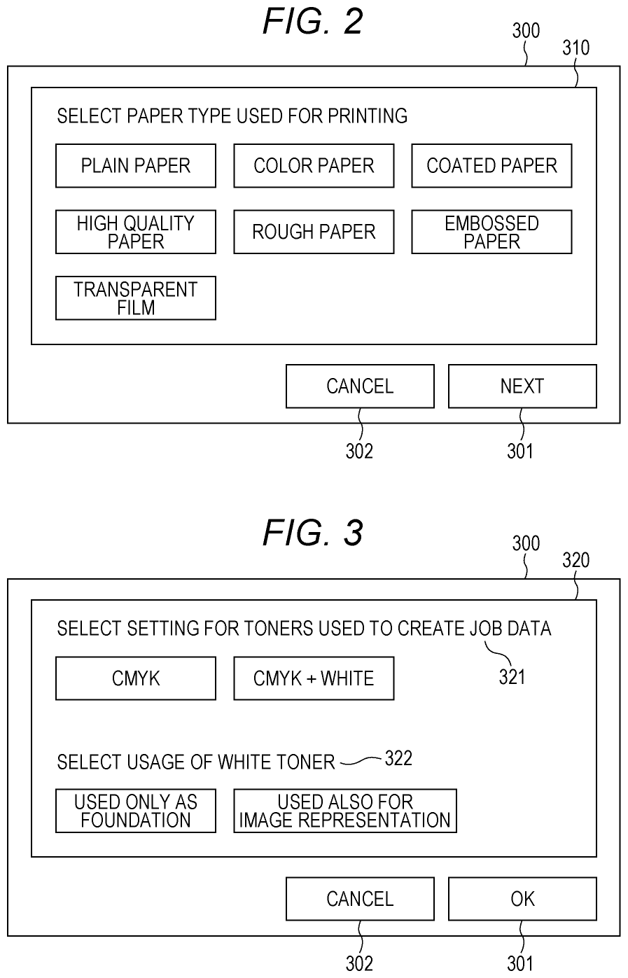

FIG. 2 is a diagram illustrating an exemplary paper type selecting screen 310 displayed on a screen 300 of the operation panel 202.

On the paper type selecting screen 310, buttons indicating paper types of “Plain Paper,” “Color Paper,” “Coated Paper,” “High Quality Paper,” “Rough Paper,” “Embossed Paper,” and “Transparent Film” are displayed. Among these buttons, the user selects a paper to be used for printing, and then presses a button 301 indicating “Next.” Alternatively, the selection is canceled with a button 302 indicating “Cancel.”

From such a paper type selecting screen 310, the type of paper to be printed by the printer 206 can be selected. When there is operation of selecting a paper on the paper type selecting screen 310, the paper type of a printed matter to be inspected by the image inspection device 210 is also selected as the corresponding paper.

FIG. 3 is a diagram illustrating an exemplary toner setting screen 320 displayed on the screen 300 of the operation panel 202. When printing is performed on a transparent support medium such as a transparent film, a white layer of white toner is formed as foundation in order to improve development of colors, and a color image is formed by CMYK toners over the white layer. The white toner may also be used for white parts in a formed image in addition to the use as such foundation.

In this example, the use state of the white toner is set by the user operation using the toner setting screen 320 illustrated in FIG. 3. That is, as a setting screen 321 of toners used for creation of the job data, a button for setting using only CMYK toners and a button for setting using the CMYK toners and the white toner are displayed.

In addition, as a setting screen 322 of the use state of the white toner, a button for use only as foundation and a button for use also as image representation are displayed. After making a selection corresponding to the data to be printed among these buttons, the user presses the button 301 indicating “Next.” Alternatively, the selection is canceled with a button 302 indicating “Cancel.”

Returning to the description of FIG. 1, the image inspection device 210 includes an inspection controller 211, a read image data determiner 212, an image reader 213, and a background color switcher 214.

The inspection controller 211 performs control for inspection in accordance with the image reading conditions input by the user on the operation panel 202 of the image forming apparatus 200. As one type of control here, there is processing of determining whether the color of a background plate for image reading for inspection is to be black or white and using the determined background color.

The read image data determiner 212 performs inspection processing of comparing read image data for comparison acquired in advance for inspection with image data read from the printed matter and determining whether the product is non-defective or a defective.

When receiving an instruction from the operation panel 202 of the image forming apparatus 200, the image reader 213 reads an image formed on the printed matter. The image reader 213 is capable of reading the front side and the back side of the paper (transparent film).

The background color switcher 214 switches the background color when the image reader 213 reads the image to either black or white on the basis of an instruction from the inspection controller 211. The background color switcher 214 is capable of separately setting the background color for reading the front side and the background color for reading the back side.

### 2. Configuration of Image Inspection Device

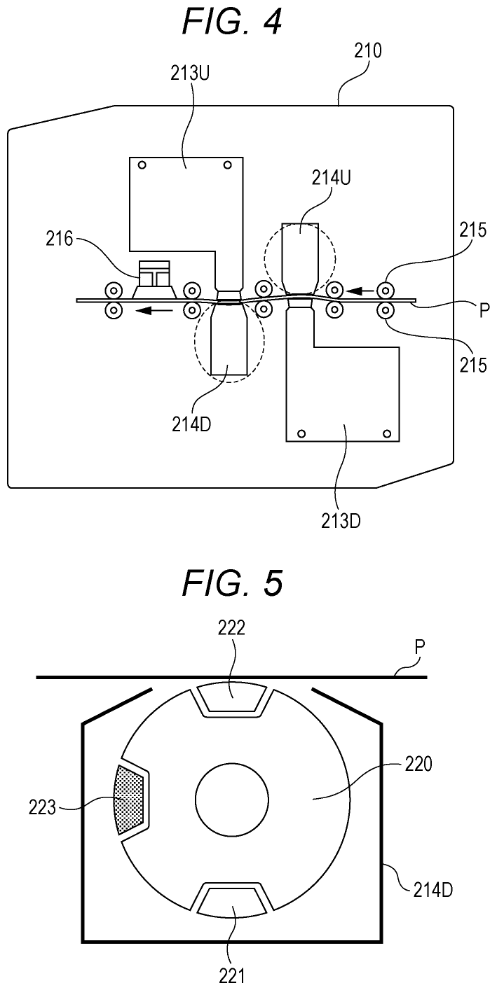

FIG. 4 is a diagram illustrating the structure of the image inspection device 210.

The image inspection device 210 includes, as the image reader 213, a front side reading unit 213U and a back side reading unit 213D. In addition, as the background color switcher 214, a front side background color switching unit 214U and a back side background color switching unit 214D are included.

The front side reading unit 213U and the back side reading unit 213D each incorporate an image reading sensor. The image reading sensor incorporated in the front side reading unit 213U reads an image visible on the front side of the printed paper P. The image reading sensor incorporated in the back side reading unit 213D reads an image visible on the back side of the printed paper P.

The front side background color switching unit 214U is arranged at a position facing the back side reading unit 213D with a conveyance path of the printed paper P sandwiched therebetween.

The back side background color switching unit 214D is arranged at a position facing the front side reading unit 213U with the conveyance path of the printed paper P sandwiched therebetween.

As illustrated in FIG. 4, the printed paper P passes through the part where the front side reading unit 213U and the back side reading unit 213D are arranged by a plurality of rollers 215 and is ejected to the outside of the image inspection device 210.

Note that a colorimeter 216 is arranged in the image inspection device 210, and the color of the image formed on the printed paper P can be also inspected.

FIG. 5 is a diagram illustrates the overall structure of the back side background color switching unit 214D. Note that the front side background color switching unit 214U has the same structure as that of the back side background color switching unit 214D.

The back side background color switching unit 214D includes a rotation mechanism 220, and the position in contact with the paper P can be selected from the three of a non-inspection background 221, a white background 222, and a black background 223 depending on the rotation position of the rotation mechanism 220. The positions of these three backgrounds 221 to 223 are determined under the control of the inspection controller 211.

### 3. Flow of Inspection Processing by Image Inspection Device

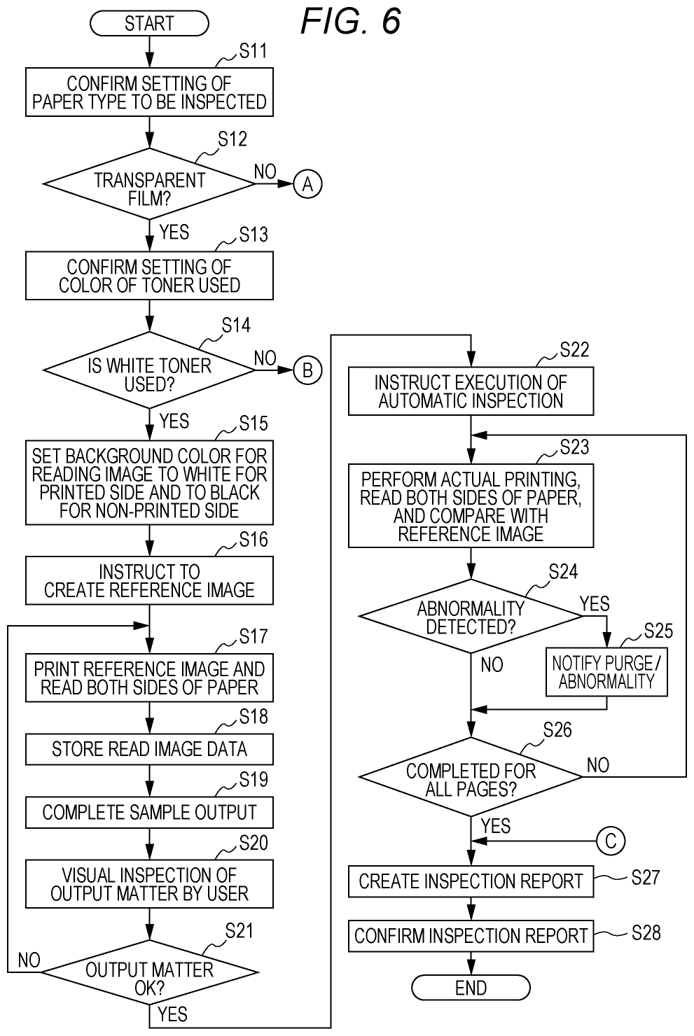

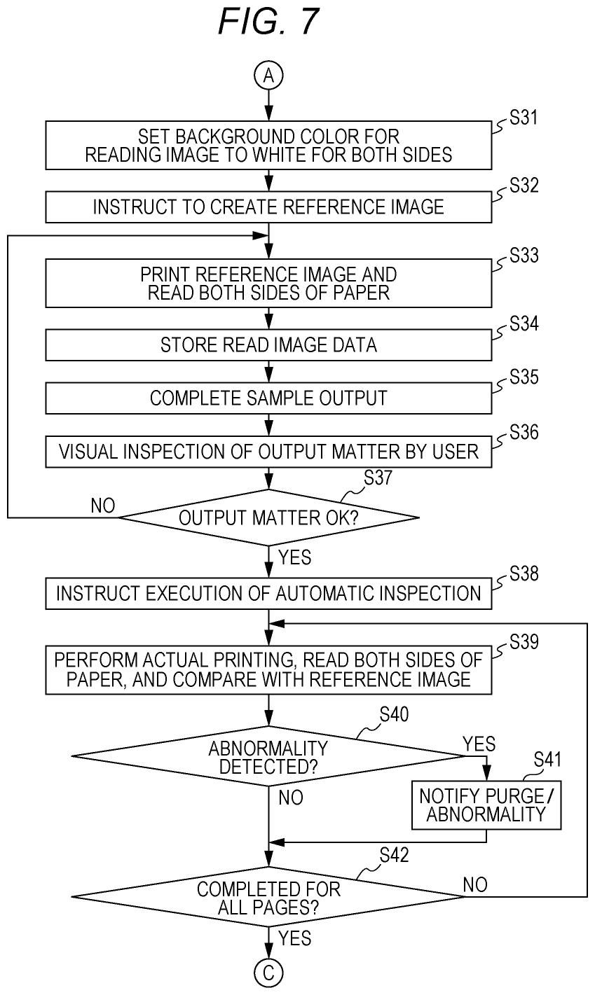

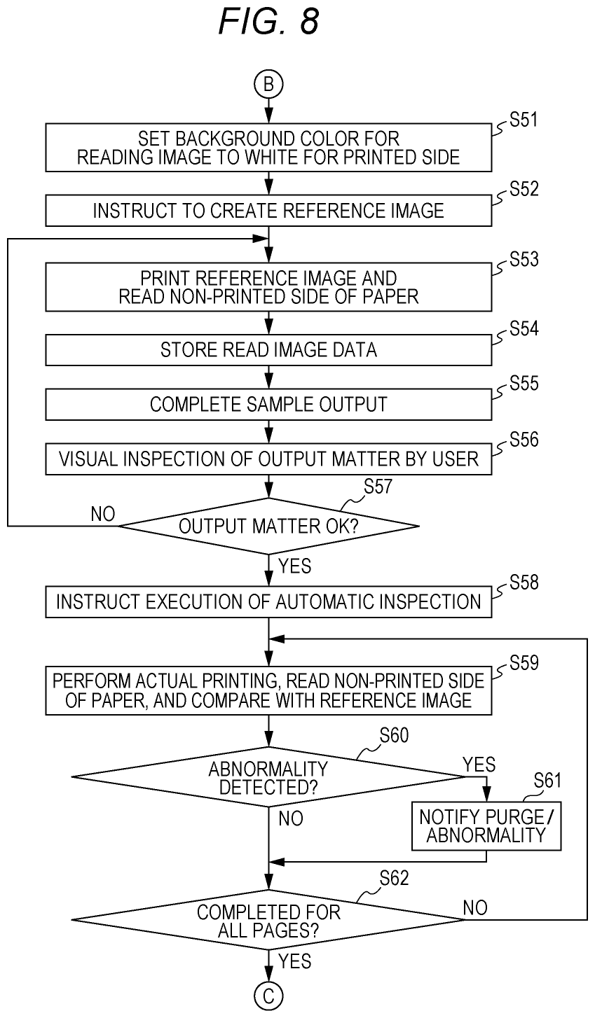

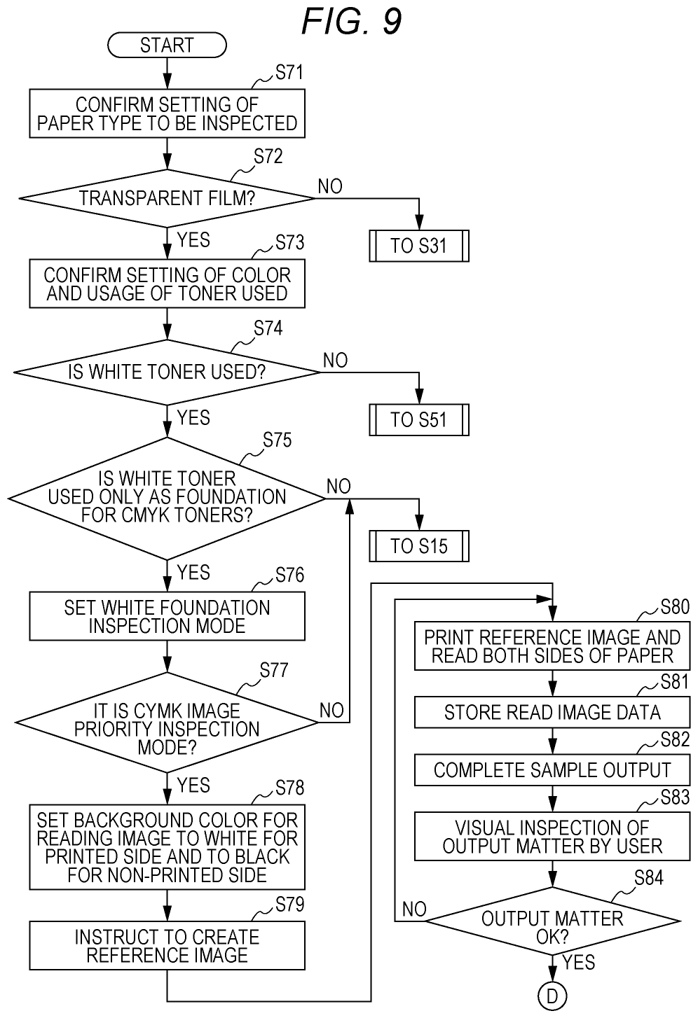

Next, a flow of the inspection processing performed by the image inspection device 210 will be described with reference to the flowcharts of FIGS. 6 to 8. An “A” part of the flowchart of FIG. 6 is connected to an “A” part of the flowchart of FIG. 7, and a “B” part of the flowchart of FIG. 6 is connected to a “B” part of the flowchart of FIG. 8. In addition, a “C” part of the flowcharts of FIGS. 7 and 8 is connected to a “C” part of the flowchart of FIG. 6.

First, the inspection controller 211 confirm the setting of the paper type to be inspected set by the user operation using the operation panel 202 (step S11). The setting of the paper type is performed on the screen illustrated in FIG. 2.

Then, the inspection controller 211 determines whether the set paper type is a transparent film (step S12). Here, if the set paper type is a transparent film (Yes in step S12), the inspection controller 211 confirms the setting of the color and usage of toners used (step S13). The setting of the color and usage of toners used is performed on the screen illustrated in FIG. 3.

Then, the inspection controller 211 determines whether a white toner is used in the printed matter (step S14). Here, if a white toner is used in the printed matter (Yes in step S14), the inspection controller 211 sets the color of the background plate for image reading to white on the printed side and to black on the non-printed side (step S15). For example, in a case where the back side of the transparent film is printed, the background color of the back side background color switching unit 214D that determines the background color for the front side reading unit 213U, which reads the front side of the transparent film, is rendered white. In addition, the background color of the front side background color switching unit 214U that determines the background color for the back side reading unit 213D, which reads the back side of the transparent film, is rendered black.

After the setting for inspection is made as described above, the user instructs to create a reference image to be used for the inspection by operation on the operation panel 202 (step S16). The reference image corresponds to a master image a print result of which is regarded correct.

Then, on the basis of the instruction to create the reference image, the printer 206 executes printing of the reference image on a transparent film. Then, the front side reading unit 213U in the image reader 213 reads the front side of the printed matter, and the back side reading unit 213D reads the back side of the printed matter (step S17).

The read image data of the front side and the back side obtained in step S17 is stored in the storage 204 (step S18), and the printed matter as a sample in which the reference image is formed on the transparent film is output from a paper ejection tray (not illustrated) of the image forming apparatus 200 (step S19).

Then, the user visually confirms the sample printed matter (step S20) and determines whether there is a problem in the printing state (step S21).

If there is a problem in the printing state by the visual confirmation here (No in step S21), the flow is repeated from the printing processing of the sample in step S17 by user operation to perform processing of obtaining an appropriate sample printed matter.

If an appropriate sample is obtained without any problem in the printing state by the visual confirmation in step S21 (Yes in step S21), the user instructs execution of automatic inspection by operation on the operation panel 202 (step S22).

On the basis of the execution instruction of automatic inspection, the printer 206 starts the actual printing of prepared image data, and the inspection controller 211 instructs reading of both sides of the printed matter under the conditions set in step S15. Then, the read image data determiner 212 compares read image data of the actual printed matter with the read image data of the stored sample printed matter page by page (step S23). In the comparison in step S23, the read image data determiner 212 determines whether an abnormality in which both pieces of image data are different is detected (step S24).

If an abnormality is detected (Yes in step S24), a corresponding page is subjected to purge processing, and the inspection controller 211 performs abnormality notification processing (step S25). The purge processing here is to eject the corresponding page to a separate tray other than a tray to which printed pages without an abnormality in the inspection result are ejected. As the abnormality notification processing, for example, the inspection controller 211 notifies the client PC 100 (FIG. 1) that there is a page in which an abnormality has occurred. Alternatively, notification of the occurrence of an abnormality (so-called alert notification) may be sent to a predetermined terminal by an e-mail.

Then, after the purge processing and the abnormality notification processing are performed in step S25, and if no abnormality is detected in step S24 (No in step S24), the inspection controller 211 determines whether printing and inspection of all pages have been completed (step S26). If it is determined here that printing has not been completed (No in step S26), the flow returns to printing and reading processing in step S23.

If it is determined in step S26 that printing has been completed (Yes in step S26), the inspection controller 211 creates an inspection report indicating the page in which the abnormality has been detected, the occurrence status of the abnormality, and the like and causes the printer 206 to print the created inspection report (step S27). The printed inspection report is confirmed by the user (step S28).

Next, processing in a case where it is determined in step S12 that printing is not on a transparent film is illustrated in FIG. 7.

If it is determined in step S12 that printing is not on a transparent film (No in step S12), the flow proceeds to step S31 in FIG. 7, and the inspection controller 211 sets the color of the background plate for image reading to white on both sides (step S31). That is, both the front side background color switching unit 214U and the back side background color switching unit 214D are set to a white background color.

Then, the user instructs creation of the reference image (master image) to be used for inspection by operation on the operation panel 202 (step S32). On the basis of the instruction to create the reference image, the printer 206 executes printing of the reference image on a paper, and the front side reading unit 213U in the image reader 213 reads the front side of the printed matter, and the back side reading unit 213D reads the back side of the printed matter (step S33).

The read image data of the front side and the back side obtained in step S33 is stored in the storage 204 (step S34), and the printed matter as a sample in which the reference image is formed on the paper is output from the paper ejection tray (not illustrated) of the image forming apparatus 200 (step S35).

Then, the user visually confirms the sample printed matter (step S36) and determines whether there is a problem in the printing state (step S37).

If there is a problem in the printing state by the visual confirmation here (No in step S37), the flow is repeated from the printing processing of the sample in step S33 by user operation to perform processing of obtaining an appropriate sample printed matter.

If an appropriate sample is obtained without any problem in the printing state by the visual confirmation in step S37 (Yes in step S37), the user instructs execution of automatic inspection by operation on the operation panel 202 (step S38).

On the basis of the execution instruction of automatic inspection, the printer 206 starts the actual printing of prepared image data, and the inspection controller 211 instructs reading of both sides of the printed matter under the conditions set in step S31. Then, the read image data determiner 212 compares read image data of the actual printed matter with the read image data of the stored sample printed matter page by page (step S39). In the comparison in step S39, the read image data determiner 212 determines whether an abnormality in which both pieces of image data are different is detected (step S40).

If an abnormality is detected (Yes in step S40), a corresponding page is subjected to purge processing, and the inspection controller 211 performs abnormality notification processing (step S41). The purge processing and the abnormality notification processing here may be the same as the purge processing and the abnormality notification processing in step S25 (FIG. 6).

Then, after the purge processing and the abnormality notification processing are performed in step S41, and if no abnormality is detected in step S40 (No in step S40), the inspection controller 211 determines whether printing and inspection of all pages have been completed (step S42). If printing has not been completed here (No in step S42), the flow returns to printing and reading processing in step S39.

If it is determined in step S42 that printing has been completed (Yes in step S42), the flow proceeds to step S27 in the flowchart of FIG. 6, and the inspection controller 211 creates an inspection report indicating the page in which the abnormality has been detected, the occurrence status of the abnormality, and the like and causes the printer 206 to print the created inspection report (step S27). The printed inspection report is confirmed by the user (step S28).

Next, processing for a case where the white toner is not used for printing on the transparent film in step S14 is illustrated in FIG. 8.

Here, if the white toner is not used for printing on the transparent film (No in step S14), the inspection controller 211 sets the color of the background plate for image reading to white on the printed side (step S51). For example, in a case where the back side of the transparent film is printed, the background color of the back side background color switching unit 214D that determines the background color for the front side reading unit 213U, which reads the front side of the transparent film, is rendered white. Note that the background color for the non-printed side may be any color. Alternatively, the non-inspection background 221 illustrated in FIG. 5 may be selected.

After the setting for inspection is made in this manner, the user instructs creation of a reference image (master image) to be used for the inspection by operation on the operation panel 202 (step S52).

Then, on the basis of the instruction to create the reference image, the printer 206 executes printing of the reference image on the transparent film, and the non-printed side in the image reader 213 is read (step S53). For example when the printed side of the transparent film is the back side, the front side reading unit 213U reads the front side of the printed matter.

The read image data of one side (front side or back side) obtained in step S53 is stored in the storage 204 (step S54), and the printed matter as a sample in which the reference image is formed on the transparent film is output from a paper ejection tray (not illustrated) of the image forming apparatus 200 (step S55).

Then, the user visually confirms the sample printed matter (step S56) and determines whether there is a problem in the printing state (step S57).

If there is a problem in the printing state by the visual confirmation here (No in step S57), the flow is repeated from the printing processing of the sample in step S53 by user operation to perform processing of obtaining an appropriate sample printed matter.

If an appropriate sample is obtained without any problem in the printing state by the visual confirmation in step S57 (Yes in step S57), the user instructs execution of automatic inspection by operation on the operation panel 202 (step S58).

On the basis of the execution instruction of automatic inspection, the printer 206 starts the actual printing of prepared image data, and the inspection controller 211 instructs reading of both sides of the printed matter under the conditions set in step S51. Then, the read image data determiner 212 compares read image data of the actual printed matter with the read image data of the stored sample printed matter page by page (step S59). In the comparison in step S59, the read image data determiner 212 determines whether an abnormality in which both pieces of image data are different is detected (step S60).

If an abnormality is detected (Yes in step S60), a corresponding page is subjected to purge processing, and the inspection controller 211 performs abnormality notification processing (step S61). The purge processing and the abnormality notification processing here may be the same as the purge processing and the abnormality notification processing in step S25 (FIG. 6).

Then, after the purge processing and the abnormality notification processing are performed in step S61, if no abnormality is detected in step S60 (No in step S60), the inspection controller 211 determines whether printing and inspection of all pages have been completed (step S62). If printing has not been completed here (No in step S62), the flow returns to printing and reading processing in step S59.

If it is determined in step S62 that printing has been completed (Yes in step S62), the flow proceeds to step S27 in the flowchart of FIG. 6. Then, the inspection controller 211 creates an inspection report indicating the page in which the abnormality has been detected, the occurrence status of the abnormality, and the like and causes the printer 206 to print the created inspection report (step S27). The printed inspection report is confirmed by the user (step S28).

As described above, according to the image inspection device 210 of the embodiment, when a printed matter using a transparent support medium such as a transparent film is obtained, a printing defect can be accurately detected by reading the same printed matter by the image reader 213 for a plurality of times on the front side and the back side. For example in a case where a white layer is formed by the white toner as foundation on one side of the transparent film and a color image is formed in a layer over the foundation by CMYK toners, the white toner layer is read by the back side reading unit 213D with a black background color. Therefore, a printing defect in the foundation layer formed by the white toner can be accurately detected.

Meanwhile, the layer of CMYK toners is read by the front side reading unit 213U with a white background color. Therefore, a printing defect in the layer of CMYK toners can be accurately detected.

### 4. Exemplary Flow of Other Inspection Processing

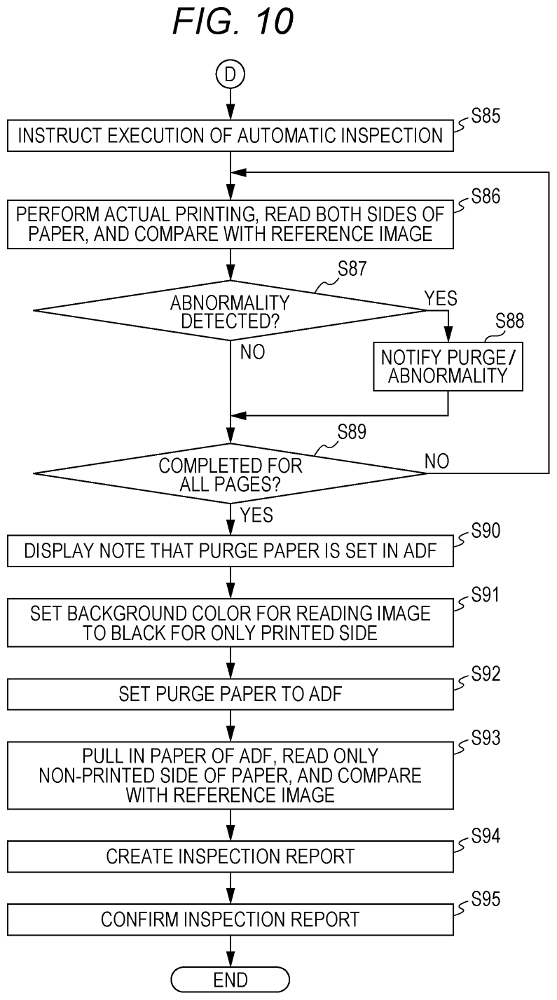

Next, inspection processing illustrated in the flowcharts of FIGS. 9 and 10 illustrates another example different from the inspection processing described above in the flowcharts of FIGS. 6 to 8. A “D” part of the flowchart of FIG. 9 is connected to a “D” part of the flowchart of FIG. 10.

The inspection processing illustrated in the flowcharts of FIGS. 9 to 10 is an example in the case where a white toner is used also for image formation other than the foundation.

First, the inspection controller 211 confirms the setting of the paper type to be inspected set by the user operation using the operation panel 202 (step S71). The setting of the paper type is performed on the screen illustrated in FIG. 2.

Then, the inspection controller 211 determines whether the set paper type is a transparent film (step S72). Here, if the set paper type is not the transparent film (No in step S72), the inspection controller 211 proceeds to step S31 in the flowchart of FIG. 7.

Further, if it is determined in step S72 that the set paper type is the transparent film (Yes in step S72), the inspection controller 211 confirms the setting of the color and usage of toners used (step S73). The setting of the color and usage of toners used is performed on the screen illustrated in FIG. 3.

Then, the inspection controller 211 determines whether a white toner is used in the printed matter (step S74). Here, if the white toner is not used in the printed matter (No in step S74), the inspection controller 211 proceeds to step S51 in the flowchart of FIG. 8.

Alternatively, if it is determined in step S74 that the white toner is used in the printed matter (Yes in step S74), the inspection controller 211 determines whether the white toner is used only as foundation of the image formed by the CMYK toners (step S75). Here, if the white toner is not only the foundation (No in step S75), the inspection controller 211 proceeds to step S15 in the flowchart of FIG. 6.

If it is determined in step S75 that the white toner is used only as the foundation (Yes in step S75), the user sets the inspection mode related to the foundation of the white toner by operation using the operation panel 202 (step S76). As the inspection mode set here, a CMYK image priority inspection mode and a white toner foundation details inspection mode are prepared to allow the user to select either one.

Here, in the white toner foundation details inspection mode, the foundation of the white toner is inspected from the printed side close to the white toner layer, and when it is detected that the image has an abnormality, it is determined that there is an abnormality in the final inspection result.

On the other hand, in the CMYK image priority inspection mode, even when there is an image abnormality in the foundation formed by the white toner, if the image abnormality of the foundation of the white toner is on a “not noticeable” level when the final printing state is observed from the front side, it is determined that there is no abnormality in the final inspection result. Note that it is preferable to describe in a report of the inspection result that an abnormality has been detected in the foundation even when it is determined that the printed matter as a product has been determined to be free from abnormalities.

Next, the inspection controller 211 determines whether the inspection mode set by the user in step S76 is the CMYK image priority inspection mode (step S77). Here, if the CMYK image priority inspection mode is not set, that is, if the white toner foundation details inspection mode is set (No in step S77), the inspection controller 211 proceeds to step S15 in the flowchart of FIG. 6.

If it is determined in step S77 that the CMYK image priority inspection mode is set (Yes in step S77), the inspection controller 211 sets the background color switcher (for example, the front side background color switching unit 214U) facing the reading unit on the printed side (for example, the back side reading unit 213D) to black. In addition, the background color switcher (for example, the back side background color switching unit 214D) facing the reading unit on the non-printed side (for example, the front side reading unit 213U) is set to white (step S78).

After the setting is made in this manner, the user instructs creation of a reference image (master image) to be used for the inspection by operation on the operation panel 202 (step S79).

Then, on the basis of the instruction to create the reference image, the printer 206 executes printing of the reference image on a transparent film, and the front side reading unit 213U in the image reader 213 reads the front side of the printed matter, and the back side reading unit 213D reads the back side of the printed matter (step S80).

The read image data of the front side and the back side obtained in step S80 is stored in the storage 204 (step S81), and the printed matter as a sample in which the reference image is formed on the transparent film is output from the paper ejection tray (not illustrated) of the image forming apparatus 200 (step S82).

Then, the user visually confirms the sample printed matter (step S83) and determines whether there is a problem in the printing state (step S84).

If there is a problem in the printing state by the visual confirmation here (No in step S84), the flow is repeated from the printing processing of the sample in step S80 by user operation to perform processing of obtaining an appropriate sample printed matter.

If an appropriate sample is obtained without any problem in the printing state by the visual confirmation in step S84 (Yes in step S84), the user instructs execution of automatic inspection by operation on the operation panel 202 (step S85 in FIG. 10).

On the basis of the execution instruction of automatic inspection, the printer 206 starts the actual printing of prepared image data, and the inspection controller 211 instructs reading of both sides of the printed matter under the conditions set in step S78. Then, the read image data determiner 212 compares read image data of the actual printed matter with the read image data of the stored sample printed matter page by page (step S86). In the comparison in step S86, the read image data determiner 212 determines whether an abnormality in which both pieces of image data are different is detected (step S87).

If an abnormality is detected (Yes in step S87), a corresponding page is subjected to purge processing, and the inspection controller 211 performs abnormality notification processing (step S88).

Then, after the purge processing and the abnormality notification processing are performed in step S88, if no abnormality is detected in step S87 (No in step S87), the inspection controller 211 determines whether printing and inspection of all pages have been completed (step S89). If it is determined here that printing has not been completed (No in step S89), the flow returns to printing and reading processing in step S86.

When it is determined in step S89 that printing has been completed (Yes in step S89), the inspection controller 211 instructs on the operation panel 202 to return the paper (transparent film) ejected in the purge processing to an auto document feeder (ADF) (not illustrated) of the image forming apparatus 200 (step S90). Then, the inspection controller 211 sets the background color for reading the document to black only on the printed side (step S91).

Thereafter, the user sets the purged paper (transparent film) in the auto document feeder (step S92). Then, inspection processing is performed on the paper set in step S92 (step S93). The inspection processing here corresponds to the inspection processing from step S16 to step S22 in the flowchart of FIG. 6. However, in step S93, the image reader 213 reads only the non-printed side. Then, in the inspection processing in step S93, the read image data is compared with the reference image data to obtain an inspection result.

Then, the inspection controller 211 creates an inspection report indicating the page in which the abnormality has been detected, the occurrence status of the abnormality, and the like and causes the printer 206 to print the created inspection report (step S94). The printed inspection report is confirmed by the user (step S95).

### 5. Variations

In the configuration described above, the image reader 213 of the image inspection device 210 includes the front side reading unit 213U and the back side reading unit 213D to enable reading of the both sides. However, the image reader 213 may include only the front side reading unit 213U, and the background color switcher 214 may include only the back side background color switching unit 214D. In this case, it is only required that, after the front side of the printed matter is read, a user turn over and return the read printed matter to the auto document feeder to allow the image reader 213 to read the printed matter again.

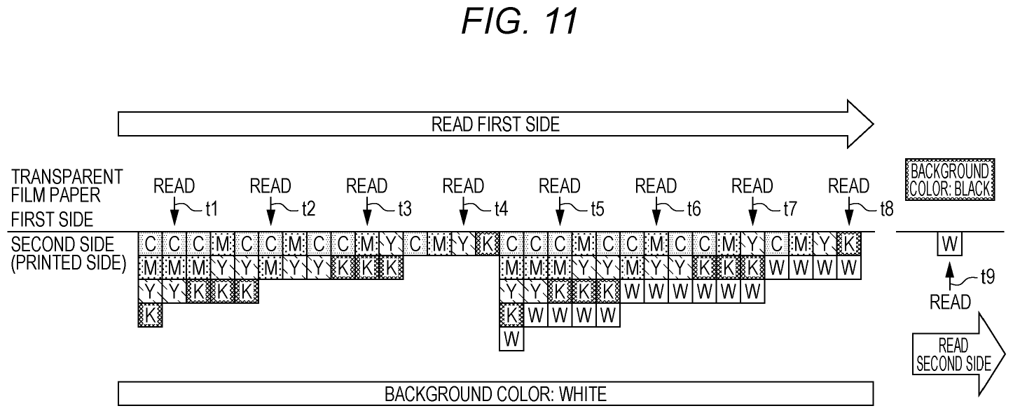

FIG. 11 is a diagram illustrating an exemplary reading state in this case.

In the example illustrated in FIG. 11, printing is not performed on the first side (front side) of the transparent film, and on the second side (back side), an image-formed surface of CMYK toners (parts applied with C, M, Y, and K toners) is formed over white foundation (parts applied with W) (closer to the first side), and an image only by the white toner is also formed.

In this example, the first side is first read sequentially as indicated by timing t1 to t8 as illustrated in FIG. 11. Although the timing t1 to t8 for reading is intermittently illustrated in FIG. 11, in practice the image is read in detail at fine intervals.

While the first side is read at the timing t1 to t8, the background color is set to white. The white background color allows the image of each part formed by the CMYK toners to be properly read.

Then, the transparent film is turned over, and the second side is read as indicated by timing t9. While the second side is read, the background color is set to black. With this black background color, it is possible to properly read the foundation formed by the white toner and the image formed only by the white toner.

Also in the case where the transparent film is turned over and the background color is changed to perform reading twice, inspection similar to the above-described embodiment can be performed. In this case, the reader is required only on one side, which simplifies the structure of the image inspection device.

Note that when more complete inspection is performed, reading may be performed a total of four times, including reading with the white background and reading with the black background on each of the front side and the back side. Alternatively, since it is only necessary to inspect the white foundation on the back side, reading may be performed only once with the black background, which totals three times of reading.

Also for the three or four times of reading, the transparent film may be returned for a corresponding number of times to allow one reader to repeatedly read as in the example of FIG. 11.

As for the operation of returning the read transparent film, the paper (transparent film) may be automatically conveyed in the image forming apparatus 200.

In the embodiment described above, the white toner layer is read with the black background, and the layer of CMYK toners is read with the white background. Meanwhile, when reading is performed by a unit that is closer to a layer in which the white color is printed in a printed matter, the background color for the reading unit may be set to black.

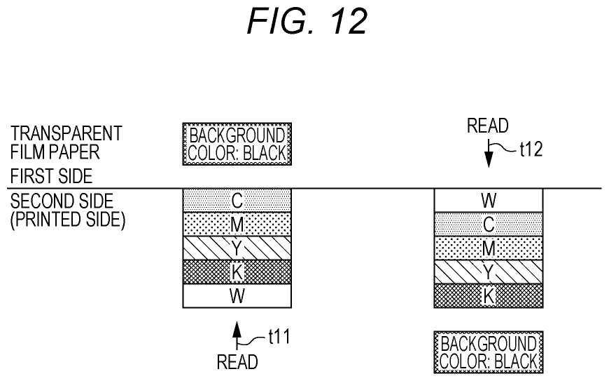

For example as illustrated in FIG. 12, a white toner layer on the second side (back side) is read with the black background color at timing t11, and then at timing t12 from the first side (front side), in a case where the layer of CMYK toners and a white toner layer are mixed, reading is performed with the black background. As for the white toner layer, there are such cases where the white toner layer is entirely halftoned or superimposed over the layer of CMYK toners, and even in these formation states, image abnormalities (stripes, unevenness, etc.) can be accurately detected.

The configurations and processing illustrated in the above-described embodiment are merely examples suitable for each case, and the present invention is not limited to the configurations or processing described above. For example in the system configuration illustrated in FIG. 1, the image forming apparatus 200 is connected to the client PC 100 via the network N, and performs printing upon an instruction from the client PC 100. However, the image forming apparatus 200 may perform printing individually.

Also in the embodiment described above, the image forming apparatus 200 incorporates the image inspection device 210. However, the image inspection device 210 may be configured separately from the image forming apparatus 200, and a paper (transparent film) on which an image is formed by the image forming apparatus 200 may be conveyed to the image inspection device 210.

Moreover, in the embodiment described above, the user selects the use state of the white toner on the setting screen. However, the inspection controller 211 may analyze an image stored in the storage 204 to automatically determine the use state of the white toner and automatically set the background color and the like for inspection.

Furthermore, in the embodiment described above, there are two colors of white and black as the background color; however, instead of white and black, two colors of a bright color other than white that is suitable for reading a color image or a black image and a dark color other than black that is suitable for reading a white layer may be used.

In the embodiment described above, the image inspection device 210 performs inspection with the reference image; however the inspection method is not limited to making a comparison with the reference image, and inspection may be performed only on an image read from the actual printing. For example, the present invention may be applied to a case where it is determined that a product is defective when it is detected that streaks occur at or above a prescribed level in an image of a printed matter.

Furthermore, although the example of printing on a transparent film has been described in the embodiment above, the present invention is also applicable to a case where a printed matter obtained by printing on other transparent support mediums, such as transparent glass, is inspected.

Although embodiments of the present invention have been described and illustrated in detail, the disclosed embodiments are made for purposes of illustration and example only and not limitation The scope of the present invention should be interpreted by terms of the appended claims.

What is claimed is:

1. An image inspection device comprising:
an image reader that reads a printed matter obtained by forming an image on a transparent support medium;
a switcher that changes a reading condition by the image reader;
a controller that performs reading in the image reader on a same printed matter for a plurality of times by changing the reading condition in the switcher; and
a determiner that inspects the printed matter on a basis of data read by the image reader for the plurality of times.

2. The image inspection device according to claim 1,
wherein the image reader comprises a front side reading unit that reads a front side of the transparent support medium and a back side reading unit that reads a back side of the transparent support medium, and
the switcher switches a background color between a first color and a second color when the printed matter is read by each of the front side reading unit and the back side reading unit.

3. The image inspection device according to claim 2,
wherein, after the controller causes the switcher to set the background color to the first color and causes the image reader to read the front side or the back side of the printed matter, the controller causes the switcher to switch the background color to the second color and causes the image reader to read the front side or the back side of the printed matter again.

4. The image inspection device according to claim 2,
wherein the controller causes the switcher to set the background color to the first color when the front side reading unit reads the front side of the transparent support medium and causes the switcher to set the background color to the second color when the back side reading unit reads the back side of the transparent support medium.

5. The image inspection device according to claim 4,
wherein the controller causes the front side reading unit and the back side reading unit to read again by causing the switcher to switch the background color for the front side and the back side.

6. The image inspection device according to claim 2,
wherein the first color is white, the second color is black, and
when reading is performed by one of the front side reading unit and the back side reading unit that is closer to a layer printed in white in the printed matter, the controller sets the background color for the reading unit to black.

7. The image inspection device according to claim 2,
wherein the first color is white, the second color is black, and
in a case where no white layer is formed in the printed matter, the controller causes one of the front side reading unit and the back side reading unit to perform reading by using white as the background color, and the determiner inspects the printed matter.

8. The image inspection device according to claim 2,
wherein the first color is white, the second color is black, and
in a case where foundation of the image formed on the printed matter is a white layer,
the controller performs inspection by setting the background color for the back side reading unit to black and setting the background color for the front side reading unit to white,
the controller determines that there is an abnormality when the determiner detects an abnormality from data read by a reading sensor of the front side reading unit, and
the controller determines that there is no abnormality as an inspection result of the printed matter when the determiner detects an abnormality from data read by a reading sensor of the back side reading unit.

9. An image forming apparatus comprising:
a printer that forms a printed matter obtained by forming an image on a transparent support medium; and
an image inspection device that inspects the printed matter formed by the printer,
wherein the image inspection device comprises:
an image reader that reads the printed matter;
a switcher that changes a reading condition by the image reader;
a controller that performs reading in the image reader on a same printed matter for a plurality of times by changing the reading condition in the switcher; and
a determiner that inspects the printed matter on a basis of data read by the image reader for the plurality of times.
